(19) United States
(12) Patent Application Publication
(10) Pub. No.: US 2024/0422529 A1
(43) Pub. Date: Dec. 19, 2024

(54) METHOD AND SYSTEM FOR e-SIM PROFILE TRANSFER ACROSS USER DEVICES

(71) Applicant: SAMSUNG ELECTRONICS CO., LTD., Suwon-si (KR)

(72) Inventor: Mallikarjuna HAMPALI, Bangalore (IN)

(21) Appl. No.: 18/744,296

(22) Filed: Jun. 14, 2024

(30) Foreign Application Priority Data
Jun. 16, 2023 (IN) 202341041181

(51) Int. Cl. H04W 8/20; H04W 8/18

(52) U.S. Cl. CPC H04W 8/205; H04W 8/183

(57) ABSTRACT

A method for transferring an embedded Subscriber Identity Module (e-SIM) profile from a first communication device to a second communication device. The method includes: receiving, at a server from the first communication device, an e-SIM transfer request message including an e-SIM identifier (EID) corresponding to each of the first communication device and the second communication device. The received e-SIM transfer request message corresponds to a request for transferring the e-SIM profile from the first communication device to the second communication device. The method also includes: performing a mapping process to map the e-SIM profile associated with the EID of the first communication device with the EID of the second communication device based on the received e-SIM transfer request message; and transmitting, to the second communication device, the e-SIM profile that is mapped with the EID of the second communication device.

### CROSS-REFERENCE TO RELATED APPLICATIONS

This application is based on and claims priority under 35 U.S.C. § 119 to Indian patent application No. 202341041181, filed on Jun. 16, 2023, in the Indian Patent Office, the disclosure of which is incorporated by reference herein in its entirety.

### BACKGROUND

### Field

The disclosure relates to the field of wireless communication systems, and for example, relates to systems and methods for e-Embedded Subscriber Identity Module (e-SIM) profile transfer across user devices.

### Description of Related Art

An e-SIM may refer to an embedded Subscriber Identity Module, also known as an embedded Universal Integrated Circuit Card (eUICC). The e-SIM is a small, programmable chip that is configurable to be embedded directly into a device, such as a smartphone, tablet, smartwatch, or Internet of Things (IoT) based electronic devices. Unlike traditional SIM cards that are physical and removable cards, the e-SIM is integrated into the device's hardware.

The e-SIM enables users to connect to a cellular network and access mobile services without a need for a physical SIM card. The e-SIM may store multiple profiles or subscriptions, allowing users to switch between different mobile network operators or plans without any need to change the SIM card manually.

However, conventional techniques for transferring the e-SIM from one device to another device, require a user to approach a Mobile Network Operator (MNO) multiple times for a transfer of an e-SIM profile. Also, the MNO needs to deploy various resources to complete the transfer procedure. Thus, conventional techniques for transferring e-SIM profiles are complex and inefficient.

Accordingly, there lies a need to overcome at least the above challenges discussed herein above with regard to the e-SIM profile transfer procedure.

### SUMMARY

According to an example embodiment of the present disclosure, disclosed herein is a method for transferring an embedded Subscriber Identity Module (e-SIM) profile from a first communication device to a second communication device. The method includes receiving, at a server from the first communication device, an e-SIM transfer request message including an e-SIM identifier (EID) corresponding to each of the first communication device and the second communication device. The received e-SIM transfer request message corresponds to a request for transferring the e-SIM profile from the first communication device to the second communication device. The method further includes: performing a mapping process to map the e-SIM profile associated with the EID of the first communication device with the EID of the second communication device based on the received e-SIM transfer request message; and transmitting, to the second communication device, the e-SIM profile that is mapped with the EID of the second communication device.

According to an example embodiment of the present disclosure, disclosed herein is a communication system for implementing the above disclosed method for transferring the embedded e-SIM profile. The communication system includes: a first communication device comprising communication circuitry, a second communication device comprising communication circuitry, and a server communicably coupled to the first communication device and the second communication device. The server includes one or more processing units including at least one processor, individually and/or collectively, configured to: receive, from the first communication device, an e-SIM transfer request message including an e-SIM identifier (EID) corresponding to each of the first communication device and the second communication device. The received e-SIM transfer request message corresponds to a request for transferring the e-SIM profile from the first communication device to the second communication device. At least one processor, individually and/or collectively, is configured to: perform a mapping process to map the e-SIM profile associated with the EID of the first communication device with the EID of the second communication device based on the received e-SIM transfer request message; and perform control to transmit, to the second communication device, the e-SIM profile that is mapped with the EID of the second communication device.

To further clarify the advantages and features of the present disclosure, a more detailed description will be rendered with reference to various example embodiments thereof, which are illustrated in the appended drawings. It will be appreciated that these drawings merely depict example embodiments and are therefore not to be considered limiting of its scope. The disclosure will be described and explained with additional specificity and detail with reference to the accompanying drawings.

### BRIEF DESCRIPTION OF THE DRAWINGS

These and other features, aspects, and advantages of certain embodiments of the present disclosure will be more apparent from the following detailed description, taken in conjunction with the accompanying drawings in which like characters represent like parts throughout the drawings, and in which:

FIG. 1 is a flowchart illustrating an example method for transferring e-SIM profiles across communication devices, according to a conventional technique;

FIG. 2 is a diagram illustrating an example workflow of e-SIM activation process, according to a conventional technique;

FIG. 3 is a block diagram illustrating an example architecture of a communication system environment for transferring an e-SIM profile from one communication device to another communication device, according to various embodiments;

FIG. 4 is a flowchart illustrating an example method for transferring the e-SIM profile across communication devices, according to various embodiments;

FIG. 5 is a signal flow diagram illustrating an example method for transferring the e-SIM profile with reference to the communication system environment of FIG. 3, according to various embodiments;

FIG. 6 is a block diagram illustrating an example configuration of a communication device, according to various embodiments;

FIG. 7 is a block diagram illustrating an example configuration of a server, according to various embodiments;

FIG. 8 is a flow diagram illustrating example e-SIM profile state transitions during transferring of the e-SIM profile, according to various embodiments;

FIG. 9 is a flow diagram illustrating example handler state transitions during transferring of the e-SIM profile, according to various embodiments; and

FIG. 10 is a flowchart illustrating an example method for transferring the e-SIM profile, according to various embodiments.

Further, skilled artisans will appreciate that, elements in the drawings are illustrated for simplicity and may not have necessarily been drawn to scale. For example, the flowcharts illustrate example methods in terms of steps involved to help to improve understanding of aspects of the present disclosure. Furthermore, in terms of the construction of the device, one or more components of the device may have been represented in the drawings by conventional symbols, and the drawings may show only those specific details that are pertinent to understanding the various example embodiments of the present disclosure so as not to obscure the drawings with unnecessary details that will be readily apparent to those of ordinary skill in the art having the benefit of the description herein.

### DETAILED DESCRIPTION

For the purpose of promoting an understanding of the principles of the disclosure, reference will now be made to the various example embodiments and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this disclosure to “an aspect”, “another aspect” or similar language may refer, for example, to a particular feature, structure, or characteristic described in connection with an embodiment being included in at least one embodiment of the present disclosure. Thus, appearances of the phrase “in an embodiment”, “in another embodiment” and similar language throughout this disclosure may, but do not necessarily, refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Embodiments of the present disclosure are generally directed towards methods and systems for transferring an embedded Subscriber Identity Module (e-SIM) profile from a first communication device to a second communication device. Specifically, the techniques and methods as disclosed herein relate to user-controlled and Discovery Server (DS) based e-SIM profile transfer across communication devices.

The terms “communication device”, “user device”, or “user communication device”, are used interchangeably throughout the description for ease of explanation.

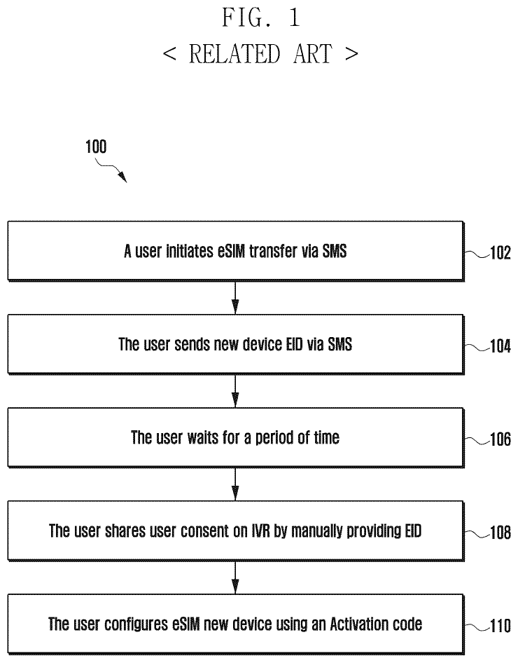

FIG. 1 is a flowchart illustrating a method 100 for transferring e-SIM across communication devices, according to a conventional technique. The method 100 includes a series of steps 102 through 110 for transferring the e-SIM across the communication devices. At step 102, a user having a communication device configured with an e-SIM may initiate an e-SIM transfer request via a Short Message Service (SMS). The e-SIM transfer request may indicate a transfer of an e-SIM profile from the communication device of the user to a new communication device. The e-SIM profile may refer to configuration settings and information associated with an e-SIM that enables the corresponding communication device to connect to a specific Mobile Network Operator (MNO). The e-SIM profile may include information that may be required for provisioning the e-SIM with a network, such information may include, but is not limited to, network credentials and connectivity parameters associated with the communication device.

At step 104, the user may send an e-SIM Identifier (EID) corresponding to the new communication device via SMS. The user may also include said EID in the e-SIM transfer request that is shared with a server managing e-SIMs and/or the MNO. The user may also transmit the e-SIM transfer request and/or the EID via any suitable transmission modes available with the communication device. Such transmission modes may include, but are not limited to, voice calls, wireless messaging, electronic mail, and so forth. The user may also transmit the e-SIM transfer request and/or the EID to the server managing e-SIMs and/or the MNO.

At step 106, the user may wait for a period of time to allow the server and/or the MNO to process said e-SIM transfer request. In general, the server and/or MNO may take around 2-3 hours to process said e-SIM transfer request. Thus, the user may need to wait at least for 2-3 hours for getting the e-SIM transfer request processed by the server and/or MNO.

The server and/or the MNO may further request the user to share user consent for the transfer of the e-SIM profile. The user may share the user consent via an Interactive Voice Response (IVR) system operated by the server and/or the MNO. For example, at step 108, the user may share the user consent on the IVR system by manually providing the EID corresponding to the new communication device. Thus, the user may need to cautiously provide the EID on the IVR system, as in case the manually shared EID on IVR system does not match with the EID shared with the SMS, the profile transfer request may be canceled by the server and/or MNO.

After successful verification of the e-SIM transfer request via the user consent, the server and/or the MNO may share an activation code to activate the e-SIM in the new communication device. Therefore, at step 110, the user may configure the e-SIM in the new communication device using the activation code provided by the server and/or the MNO.

Therefore, the conventional technique for transferring the e-SIM profile is complex and inefficient for a user and thus results in a poor user experience. Further, in a case where the user is unaware of the process for retrieving the EID, sending a request for the e-SIM profile transfer, or activating the e-SIM using the activation code, then the user may need to visit and/or contact MNO Point of Sale (POS) multiple times to accomplish these tasks.

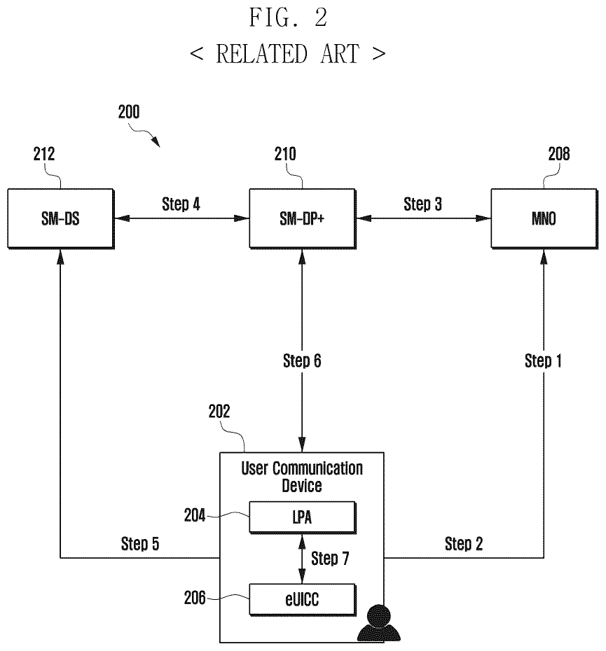

FIG. 2 is a diagram illustrating a workflow 200 of e-SIM activation process, according to a conventional technique.

At step 1, a user of an e-SIM-enabled communication device 202 connects to an MNO 208 to subscribe to a plan for the e-SIM. Examples of the communication device 202 may include, but are not limited to, a smartphone, a tablet, a laptop, a smartwatch, an Internet of Things (IoT) based devices, and the like. At step 2, the MNO 208 may scan an EID corresponding to the communication device 202 either from a packaging box of the communication device 202 and/or from a Graphical User Interface (GUI) displayed by the communication device 202.

At step 3, the MNO 208 may transmit a request for an e-SIM profile and a registration of an event to a Subscription Manager Discovery Server (SM-DS) 212 via a Subscription Manager Data Preparation (SM-DP+) server 210. The MNO 208 may also transmit information such as, but not limited to, the EID of the communication device 202, an Integrated Circuit Card Identifier (ICC ID), and an address of SM-DS 212 to the SM-DP+ server 210. The SM-DS 212 and the SM-DP+ server 210 may correspond to a system that may be configured to manage and provision e-SIM profiles at the communication device 202.

At step 4, the SM-DP+ server 210 may register the event for the EID with the SM-DS 212. Specifically, during provisioning of the e-SIM, various events may occur at the SM-DS 212. Examples of such events may include, but are not limited to, profile download request, profile validation, profile selection, profile preparation, profile provisioning, profile installation, and so forth. The registration of the event may indicate activation of any of aforementioned events at the SM-DS 212.

At step 5, a Local Profile Assistant (LPA) 204 which is implemented at the communication device 202 may submit the EID corresponding the communication device 202 to the SM-DS 212 and requests the SM-DS 212 for corresponding event information. In response, the SM-DS 212 may transmit an event ID and/or event information associated with the event registered for the corresponding EID. Based on the event ID and/or the event information, the communication device 202 may determine that the e-SIM profile corresponding to the EID of the communication device 202 is ready to install.

At step 6, the communication device 202 may download the e-SIM profile from the SM-DP+ server 210 using the received event ID. At step 7, the communication device 202 may install the downloaded e-SIM profile. Specifically, the communication device 202 may configure an embedded Universal Integrated Circuit Card (eUICC) 206 with the information included in the downloaded e-SIM profile. The eUICC 206 may be configured to implement the e-SIM functionality at the communication device using the information associated with the downloaded e-SIM profile. The eUICC 206 may be referred to as a programmable SIM card that is embedded within the communication device 202. The eUICC 206 may enable remote provisioning and management of multiple MNO profiles at the communication device 202. The eUICC 206 may be capable of storing multiple e-SIM profiles from different MNOs simultaneously. The eUICC 206 may operate in conjunction with the SM-DP+ server and SM-DS 210, 212 to manage the provisioning of the e-SIM profiles.

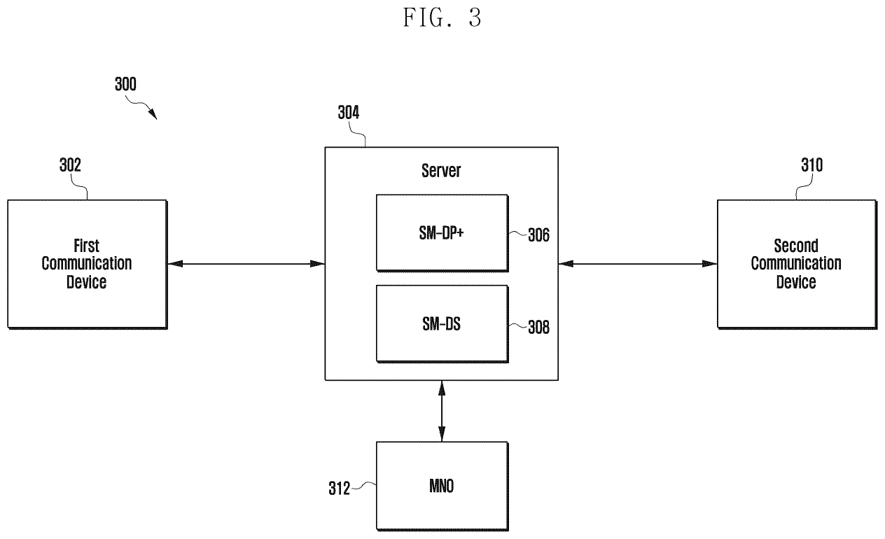

FIG. 3 is a block diagram illustrating an example architecture of a communication system environment 300 for transferring an e-SIM profile from one communication device to another communication device, according to various embodiments. The communication system 300 may include a first communication device 302, a server 304, a second communication device 310, and an MNO 312, which may be communicably coupled to each other.

Each of the first communication device 302 and the second communication device 310 may include an e-SIM-enabled communication device configured to support e-SIM operations. Examples of the first and second communication devices (302, 310) may include, but are not limited to, a smartphone, a laptop, a tablet, a smartwatch, and the like. In an embodiment, the first or the second communication device (302 or 310) may correspond to the user communication device 202, as shown in FIG. 2. Further, the first communication device 302 may include an active e-SIM profile which a user of the first communication device 302 prefers to transfer to the second communication device 310. In an embodiment, the e-SIM profile may include information such as, but not limited to, subscription-related information, one or more authentication credentials, and one or more network identifiers. The first communication device 302 may connect with the server 304 and/or the MNO 312 to perform said transfer of the e-SIM profile from the first communication device 302 to the second communication device 310.

The server 304 may include a SM-DP+ server 306 and a SM-DS 308. In an embodiment, the SM-DP+ server 306 and the SM-DS 308 may correspond to the SM-DP+ server 210 and the SM-DS 212, respectively. The SM-DP+ server 306 may be configured to generate and personalize e-SIM profiles for user devices based on one or more user requirements. The SM-DP+ server 306 may be configured to perform operations such as, but not limited to, profile generation, profile customization, profile encryption, profile delivery, profile activation, profile management, and the like. For instance, the SM-DP+ server 306 may be configured to generate e-SIM profiles based on specifications provided by the MNO 312 and/or a service provider. In various embodiments, the SM-DP+ server 306 may be configured to generate required information and configuration setting that may be required to establish a connection between the first or the second communication devices (302 or 310) with the MNO's network. Further, the SM-DP+ server 306 may be configured to customize the e-SIM profiles for specific devices and/or the user. For example, the SM-DP+ server 306 may be configured to utilize device specific information such as, but not limited to EID, International Mobile Equipment Identity (IMEI) number, or other device identifiers, to uniquely assign the e-SIM profiles to one of an intended communication device among the first or second communication device (302 or 310). Moreover, the SM-DP+ server 306 may be configured to maintain security corresponding to the e-SIM profiles during transmission of e-SIM profiles from the server 304 to one of the intended communication device 302 or 310. In particular, the SM-DP+ server 306 may be configured to encrypt the e-SIM profiles before transmission of the e-SIM profiles to the intended communication device 302 or 310. The SM-DP+ server 306 may also be configured to perform profile activation of the e-SIM profile once the e-SIM profile is installed at one of the intended communication device 302 or 310. Various embodiments that are disclosed above herein are merely examples and are not limiting in nature. A person skilled in the art may understand that these embodiments are simply a medium for providing explanations of the method for transferring the e-SIM profile and therefore may not be construed limiting in scope. Accordingly, the SM-DP+ server 306 may also be configured to perform any suitable operation that is required to manage a lifecycle of the e-SIM profiles.

The SM-DS 308 may correspond to a server component of the server 304 that stores and manages e-SIM profiles and associated data. The SM-DS 308 may be configured to act as central repository for e-SIM profile information for provisioning and managing of the e-SIM profiles. The SM-DS 308 may be configured to perform operations such as, but not limited to, profile storage, profile retrieval, profile validation, profile distribution, profile management, security and authentication, and so forth. For instance, the SM-DS 308 may be configured to securely store e-SIM profiles provided by the MNOs and/or service providers. The SM-DS 308 may also be configured to retrieve an appropriate e-SIM profile based on a request from the communication device 302, 310. Moreover, the SM-DS 308 may be configured to validate a profile download request from a user to ensure that the request has been received from an authorized communication device and/or the request complies with required security protocols. The SM-DS 308 may be configured to distribute the e-SIM profiles to the requesting communication devices and/or any intermediary servers such as, the SM-DP+SM. Further, embodiments discussed above are examples, and the SM-DS 308 may be configured to perform any suitable operation required to manage a lifecycle of the e-SIM profiles. The SM-DP+ server 306 and the SM-DS 308 may be further configured to implement the required functionalities of the server 304.

In an example embodiment, the server 304 may be configured to receive an e-SIM transfer request message from the first communication device 302. The e-SIM transfer request message may include, but not limited to, EIDs information corresponding to each of the first communication device 302 and the second communication device 310, and information associated with the transfer of the e-SIM profile from the first communication device 302 to the second communication device 310.

The server 304 may utilize the SM-DP+ server 306 and the SM-DS 308 to perform a mapping process to map the e-SIM profile associated with the EID of the first communication device 302 with the EID of the second communication device 310 based on the received e-SIM transfer request message. In an embodiment, the server 304 may be configured to identify a current state of the e-SIM profile upon receiving the e-SIM transfer request message. For instance, for an active e-SIM, the current state may correspond to an installed state of the e-SIM. The server 304 may also be configured to update the current state of the e-SIM profile to a released state upon successful mapping of the e-SIM profile with the EID of the second communication device 310. In an embodiment, the mapping process to map the e-SIM profile with the EID of the second communication device may be performed independent of original equipment manufacturer (OEM) IDs associated with each of the first communication device 302 and the second communication device 310. For example, the server 304 may not require OEM IDs associated with any of the first communication device 302 or the second communication device 310 to map the e-SIM profile to the EID of the second communication device 310 from the EID of the first communication device 302.

Further, the server 304 may be configured to transmit the e-SIM profile that is mapped with the EID of the second communication device 310 to the second communication device 310. The server 304 may also be configured to transmit a notification message to the second communication device 310 and/or the first communication device 302 that includes a request to install the e-SIM profile at the second communication device 310.

In various embodiments, the server 304 may also be configured to transmit a configuration request message to the MNO 312 to configure the transfer of the mapped e-SIM profile from the EID of the first communication device 302 to the EID of the second communication device 310. Further, in response to the transmitted configuration request message, the server 304 may be configured to receive a confirmation message from the MNO 312 that may indicate a confirmation of the configuration of the e-SIM profile from the EID of the first communication device 302 to the EID of the second communication device 310. The MNO 312 may also be configured to perform various operations which may be required during the lifecycle of e-SIM provisioning. Such operations may include, but not limited to, profile distribution, subscription activation, profile provisioning, roaming management, security and authentication, billing, and the like.

The server 304 may also be configured to detect whether the transmitted e-SIM profile has been installed on the second communication device 310. Upon detecting that the transmitted e-SIM profile has been successfully installed on the second communication device 310, the server 304 may delete the e-SIM profile from the first communication device 302. In other embodiments, the server 304 may transmit a request to the first communication device 302 with an indication for the user to delete the e-SIM profile.

The system 300 may enable a user to transfer the e-SIM profile from the first communication device 302 to the second communication device 310 without any direct communication with the MNO 312. Further, the system 300 may allow the user to transfer e-SIM profile from the first communication device 302 to the second communication device 310 without any manual consent for the EID. Therefore, the system 300 helps in improvising the overall process for e-SIM profile transfer from the first communication device 302 to the second communication device 310. Thus, the operations performed by the components of the system environment 300 results in enhancement of the user experience while transferring the e-SIM profile from the first communication device 302 to the second communication device 310.

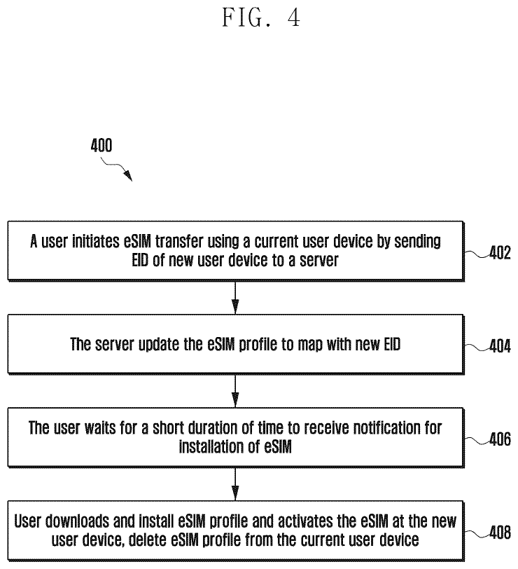

FIG. 4 is a flowchart illustrating an example method 400 for transferring the e-SIM profiles across communication devices, according to various embodiments. The method 400 may be implemented using the system environment 300 including the first communication device 302, the server 304, the second communication device 310, and/or the MNO 312.

At step 402, a user device currently being used by the user may initiate, based, for example, on a user input, an e-SIM transfer request by sending EID of a new user device to the server 304. The current user device may correspond to the first communication device 302 which includes an active e-SIM profile. Further, the new user device may correspond to the second communication device 310. The user may obtain the EID of the second communication device 310 via any suitable means such as, but not limited to, scanning a bar code associated with the second communication device 310, reading from the second communication device 310, and the like.

At step 404, the server 304 may update the e-SIM profile to map with the new EID associated with the second communication device 310.

At step 406, the user may wait for a short duration of time to receive notification for installation of the e-SIM at the second communication device 310. The short duration of time may be required by the server 304 to map the e-SIM profile with the EID of the second communication device 310. In an example embodiment, the short duration of time may correspond to 5-10 mins.

At step 408, the user may download and install the e-SIM profile on the second communication device 310. The user may also activate the e-SIM at the second communication device 310. Further, the user may delete the e-SIM profile from the first communication device 302 upon successful installation of the e-SIM profile on the second communication device 310.

Thus, the method 400 may allow a user to transmit the e-SIM profile from the first communication device 302 to the second communication device 310 effectively and efficiently.

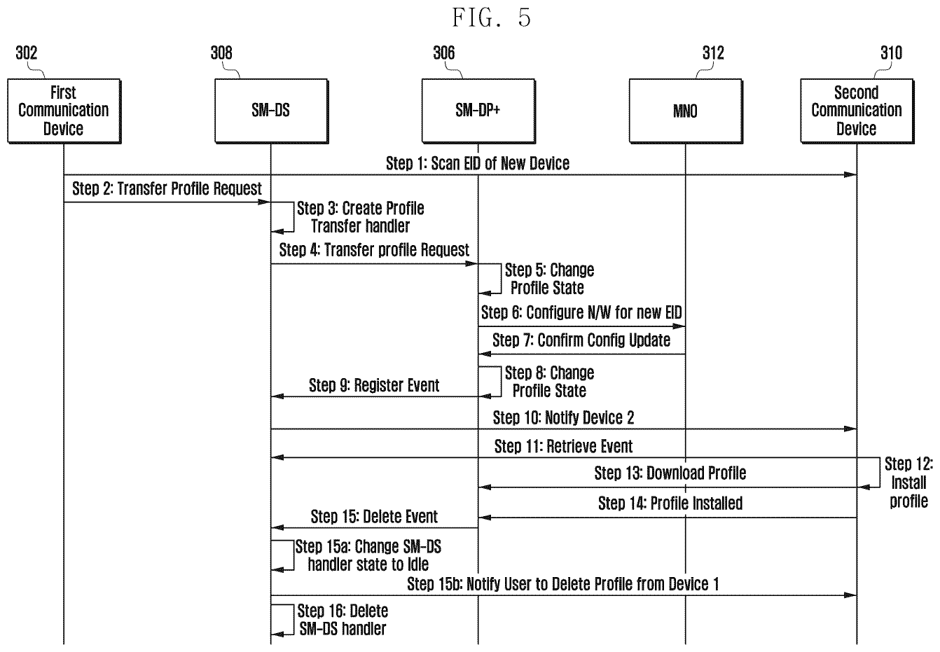

FIG. 5 is a signal flow diagram illustrating an example method for transferring e-SIM profile with reference to the communication system environment of FIG. 3, according to various. The steps illustrated in FIG. 5 correspond to various operations which may be performed by the components of the system 300 to implement the desired objective of the present disclosure e.g., to enable transfer of the e-SIM profile from the first communication device 302 to the second communication device 310. The steps are merely examples and may vary as required.

At step 1, the first communication device 302 may scan the EID of the second communication device (also referred to as “new device”) 310. The first communication device 302 may either scan the EID from a packaging box of the second communication device 310 or a Graphical User Interface (GUI) presented by the second communication device 310.

At step 2, the first communication device 302 may transmit a transfer profile request to the SM-DS 308. The transfer profile request may include information such as, but not limited to, the EID corresponding to the first communication device 302, the EID corresponding to the second communication device 310, an ICCID of the first communication device 302, and an indication to transfer an active e-SIM profile from the first communication device 302 to the second communication device 310.

At step 3, the SM-DS 308 may create a profile transfer handler to process and respond to the transfer profile request from the first communication device 302. At step 4, the profile transfer handler may generate a transfer profile request based at least on the EIDs corresponding to the first communication device 302, and the second communication device 310, and the ICCID, and transmit the generated request to the SM-DP+ server 306.

At step 5, the SM-DP+ server 306 may trigger a change in the profile state of the e-SIM profile. For instance, the SM-DP+ server 306 may trigger a change in the profile state of the e-SIM profile from an installed state to a ready state. Further, the SM-DP+ server 306 may change the ICCID mapping to the EID of the second communication device 310.

At step 6, the SM-DP+ server 306 may configure the network via the MNO 312 to support the change of state of the e-SIM profile.

At step 7, the MNO 312 may transmit a confirmation to the SM-DP+ server 306. The confirmation may indicate successful update of the configuration at the network.

At step 8, upon receiving the confirmation from the MNO 312, the SM-DP+ server 306 may change the profile state corresponding to the e-SIM profile.

At step 9, the SM-DP+ server 306 may request the SM-DS 308 to register an event corresponding to the e-SIM profile. The event may correspond to an indication stating that the e-SIM profile is ready to be installed at the second communication device 310.

At step 10, the SM-DS 308 may notify the second communication device 310 that the e-SIM profile is ready to be installed at the second communication device 310.

At step 11, the second communication device 310 may retrieve the corresponding event information from the SM-DS 308. The corresponding event information may correspond to relevant information required to install the e-SIM profile on the second communication device 310.

At step 12, the second communication device 310 may install the e-SIM profile based on the event information. For example, at step 13, the second communication device 310 may download the e-SIM profile from the SM-DP+ server 306. At step 14, the second communication device 310 may install the e-SIM profile and transmit an indication to the SM-DP+ server that the e-SIM profile has been successfully installed at the second communication device 310.

At step 15, the SM-DP+ server 306 may transmit a request to the SM-DS 308 for generating a delete event. At step 15a, the SM-DS may change the profile transfer handler state to idle. Further, at step 15b, the SM-DS 308 may notify the user to delete the e-SIM profile from the first communication device 302.

At step 16, the SM-DS 308 may delete the profile transfer handler. Thus, the e-SIM profile is transferred without any manual user consent and/or direct contact with the MNO 312.

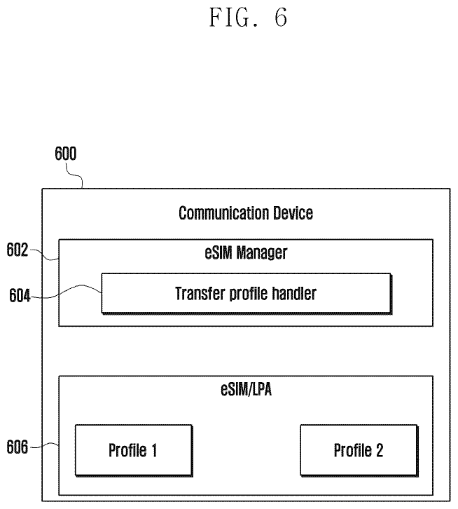

FIG. 6 is a block diagram illustrating an example configuration of a communication device 600, according to various embodiments. The communication device 600 may correspond to the first communication device 302 and/or the second communication device 310.

The communication device 600 may include an e-SIM manager (e.g., including various executable program instructions) 602 and an e-SIM and/or LPA 606. In an embodiment, the e-SIM manager 602 may correspond to a software component stored in a memory of the communication device 600. The e-SIM manager 602 may be configured to manage the e-SIM functionality at the communication device 600. The e-SIM manager 602 may be configured to support operations such as, but not limited to, e-SIM profile management, profile handler activation and deactivation, and switching between the different mobile subscriptions for the e-SIM 606. In an example embodiment, the e-SIM manager 602 may be configured to implement transfer profile handler 604 responsible for transferring the e-SIM profile from the first communication device 302 to the second communication device 310.

The transfer profile handler 604 may be implemented to facilitate the transfer of the e-SIM profiles between the different communication devices 600. For example, when the user of the communication device 600 initiate e-SIM profile transfer, the e-SIM manager 602 may initialize the transfer profile handler 604. The transfer profile handler 604 may be configured to perform user authentication and authorization to transfer the e-SIM profile. Further, the transfer profile handler 604 may be configured to establish a secure communication channel between the first communication device 302 and the second communication device 310. In an embodiment, the transfer profile handler 604 may be configured to manage a secure transmission of the e-SIM profile, ensuring the integrity and confidentiality of the data associated with the e-SIM profile. Moreover, once the e-SIM profile is transferred the profile transfer handler may communicate with the e-SIM manager of the second communication device 310 to install the e-SIM profile on an embedded Universal Integrated Circuit Card (eUICC) of the second communication device 310. Also, post completion of the e-SIM profile transfer process, the transfer profile handler 604 may verify the successful installation/activation and may recommend the user to delete the e-SIM profile from the corresponding communication device 600. In some other embodiments, the e-SIM manager 602 and/or the transfer profile handler 604 may be implemented outside the memory of the communication device 600 using any suitable hardware and/or software components such as, units and modules.

The communication device 600 may also include the e-SIM/LPA 606 that may be configured to assist the user in managing and activating e-SIM profiles (for example, profile 1 and profile 2) locally at the communication device 600. The e-SIM/LPA 606 may be configured to provide a user friendly interface to facilitate an interaction between the user and the e-SIM profiles stored on the communication device 600. The operations of the e-SIM/LPA 606 may include, but not limited to, profile discovery, profile selection, profile activation, user authentication and authorization, status monitoring, profile management, and the like.

The communication device 600 may further include various other components such as, but not limited to, memories, processors (e.g., including processing circuitry), transceivers, and so forth, which may be required to implement the basic functionality of the communication device 600. However, a description of said components has been not been provided herein for the sake of brevity of the present disclosure. However, it will be understood that in this disclosure the term “processor” may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

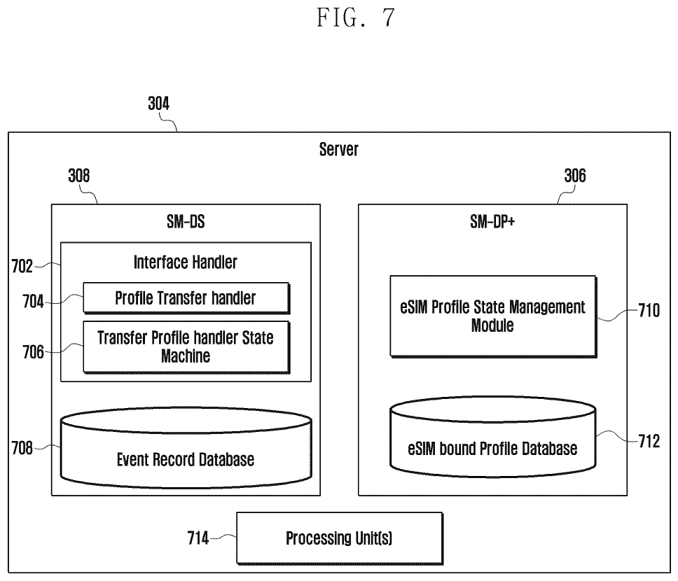

FIG. 7 is block diagram illustrating an example configuration of the server 304, according to various embodiments. The server 304 may include the SM-DS 308 and the SM-DP+ server 306. The server 304 may also include one or more processing units (e.g., including processing circuitry) 714.

The SM-DS 308 may include an interface handler 702, and a database 708 configured to store event records. The interface handler 702 may include various circuitry and/or executable program instructions, and be configured to manage communication between the server 304 and one or more external components. For example, the interface handler 702 may be configured to implement a set of protocols and Application Programming Interfaces (APIs) to perform one or more operations of the SM-DS 308. In an embodiment, the interface handler 702 may be configured to perform operations such as, but not limited to, protocol handling, authentication and security, request routing, data transformation, error handling, performance optimization, and so forth.

In an example embodiment, the interface handler 702 may implement a profile transfer handler 704 and a transfer profile handler state machine 706. The profile transfer handler 704 may correspond to an instance or a set of instructions which is configured to support e-SIM transfer operation. For example, the profile transfer handler 704 may be configured to receive and process a request from the first communication device 302 to transfer the active e-SIM profile of the first communication device 302 to the second communication device 310.

The transfer profile handler state machine 706 may correspond to an instance and/or a set of instructions configured to manage profile state of the e-SIM profiles stored at the SM-DS 308. Examples of the profile state may include, but are not limited to, an installed state, a transfer allocated state, a transfer release state, and a transfer linked state. Further, the database 708 may be configured to store various events which may occur when the e-SIM profile transfer operation is performed by the SM-DS 308.

The server 304 may also the SM-DP+ server 306. The SM-DP+ server 306 may include an e-SIM profile state management module (e.g., including various circuitry and/or executable program instructions) 710. The e-SIM profile state management module 710 may be configured to maintain a record of the profile state of the e-SIM profiles stored at the SM-DS 308.

The SM-DP+ server 306 may also include an e-SIM bound profile database 712. The e-SIM bound profile database 712 may be configured to various information associated with the e-SIM profiles stored at the server 304.

The server 304 may further include the processing unit(s) or processors 714 configured to perform one or more operations of the server 304, as discussed in reference to FIGS. 3-6. The processing unit 714 may include at least one data processor for executing processes in Virtual Storage Area Network. The processing unit 714 may include specialized processing units such as, integrated system (bus) controllers, memory management control units, floating point units, graphics processing units, digital signal processing units, etc. In an embodiment, the processing unit 714 may include a central processing unit (CPU), a graphics processing unit (GPU), or both. The processor/controller 102 may be one or more general processors, digital signal processors, application-specific integrated circuits, field-programmable gate arrays, servers, networks, digital circuits, analog circuits, combinations thereof, or other now known or later developed devices for analyzing and processing data. The processing unit 714 may execute a software program, such as code generated manually (e.g., programmed) to perform the desired operation. For example, the processing unit 714 may include various processors that may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

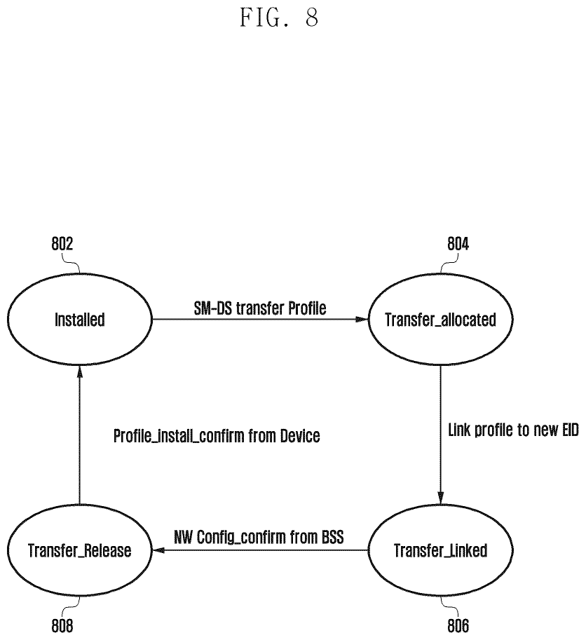

FIG. 8 is a flow diagram illustrating example e-SIM profile state transitions during a transfer of the e-SIM, according to various embodiments.

Initially, the e-SIM profile may be associated with an installed state 802. Further, when the SM-DP+ server 306 receives a request for e-SIM profile transfer from the first communication device 302 to the second communication device 310, the SM-DP+ server 306 may change the installed state 802 to the transfer allocated state 804.

When the SM-DP+ server 306 initializes linking of the e-SIM profile with the EID of the second communication device 302 and transmits a reconfiguration message to the MNO 312, the SM-DP+ server 306 may change the profile state from the transfer allocated state 804 to the transfer linked state 806. For example, the transfer linked state 806 may indicate that SM-DP+ server 306 has updated the associated database to associate the e-SIM profile with the EID corresponding to the second communication device 310.

Upon receiving a confirmation from the network and/or the MNO 312 indicating that the configuration has been successfully completed, the SM-DP+ server 306 may change the profile state from the transfer linked state 806 to the transfer release state 808. Further, when the SM-DP+ server 306 receives a confirmation from the second communication device 310 indicating a successful installation of the e-SIM profile at the second communication device 310, the SM-DP+ server 306 may change the profile state corresponding to the e-SIM profile from transfer release state 808 to the installed state 802. The installed state 802 may indicate completion of the e-SIM profile transfer to the second communication device 310.

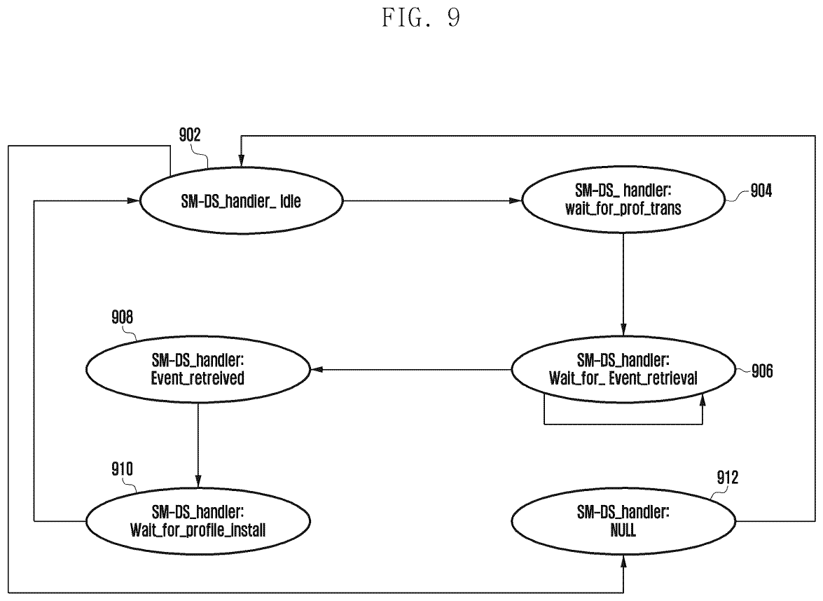

FIG. 9 is a flow diagram illustrating example handler state transitions during transferring of the e-SIM profile, according to various embodiments. The handler state transitions may include a series of operation events 902 through 912. At operation 902, the SM-DS 308 may receive the profile transfer request from first communication device 302. Further, in response to the said request for the profile, the SM-DS 308 may create the SM-DS_handler instance 902 in an idle state for handling the e-SIM profile transfer. Further, at operation 904, the SM-DS 308 may send the request for the e-SIM profile transfer to the SM_DP+ server 306. At this instance, the SM-DS 308 may change the SM-DS_handler instance 904 in a state indicating wait for the profile transfer. Furthermore, at operation 906, the SM-DS 308 may receive a register of event records from the SM-DP+ server 306 in response to the request for the e-SIM profile transfer. At this instance, the SM-DS 308 may change the SM-DS_handler instance 906 to a state indicating wait for the event retrieval.

Moreover, at operation 908, the SM-DS 308 may receive an event retrieval message from the second communication device 310. At this instance, the SM-DS 308 may change the SM-DS_handler instance 908 to a state indicating event retrieved. Thereafter, at operation 910, the second communication device 310 will download the eSIM profile from SM-DP+ Server 306 and SM-DP+ server 306 intern will indicate this to SM-DS server 308. At this instance, the SM-DS 308 may change the SM-DS_handler instance 910 to a state indicating wait for the installation of the profile. Further, when the SM-DS_handler instance is changed to the state indicating the wait for the installation of the profile, then the SM-DS 308 (at operation 902) may receive a delete event from the SM-DP+ server 306. At this instance, the SM-DS 308 may change the SM-DS_handler instance 902 to an idle state. Further, once the SM-DS_handler instance 902 is changed to the idle state, then the SM-DS 308 (at operation 912) may send a notification to the second communication device 310 for deleting the e-SIM profile from the first communication device 302 and accordingly the SM-DS_handler instance 912 is changed to a NULL state.

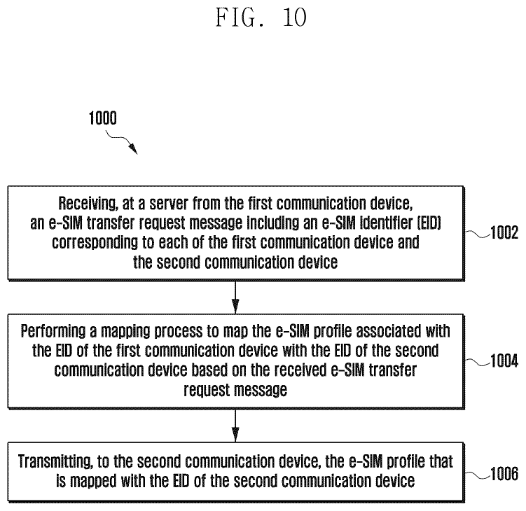

FIG. 10 is a flowchart illustrating an example method 1000 for transferring an e-SIM profile, according to various embodiments.

At step 1002, the method 1000 may include receiving, at the server 304 from the first communication device 302, an e-SIM transfer request message including an e-SIM identifier (EID) corresponding to each of the first communication device 302 and the second communication device 310. The received e-SIM transfer request message corresponds to a request for transferring the e-SIM profile from the first communication device 302 to the second communication device 310.

At step 1004, the method 1000 may include performing a mapping process to map the e-SIM profile associated with the EID of the first communication device 302 with the EID of the second communication device 310 based on the received e-SIM transfer request message.

At step 1006, the method 1000 may include transmitting the e-SIM profile that is mapped with the EID of the second communication device 310 to the second communication device 310.

The method 1000 may also include transmitting a configuration request message to the MNO 312 to configure a transfer of the mapped e-SIM profile from the EID of the first communication device 302 to the EID of the second communication device 310. The method 100 may also include receiving, from the MNO 312 in response to the transmitted configuration request message, a confirmation message indicating a confirmation of the configuration of the e-SIM profile from the EID of the first communication device 302 to the EID of the second communication device 310.

Embodiments as discussed above are simply examples and the method 1000 may include any additional step or omit any of above-mentioned step to perform the present disclosure. Further, the steps of the method 1000 may be performed in any suitably order in order to achieve the desired advantages.

Accordingly, based on the above disclosed various embodiments the e-SIM profile transfer may be enabled and processed efficiently and hence enhances the user experience during the e-SIM profile transfer.

While the disclosure has been illustrated and described with reference to various example embodiments, it will be understood that the various example embodiments are intended to be illustrative, not limiting. It will be further understood by one skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for transferring an embedded Subscriber Identity Module (e-SIM) profile from a first communication device to a second communication device, the method comprising:
receiving, at a server from the first communication device, an e-SIM transfer request message including an e-SIM identifier (EID) corresponding to each of the first communication device and the second communication device, wherein the received e-SIM transfer request message corresponds to a request for transferring the e-SIM profile from the first communication device to the second communication device;
performing a mapping process to map the e-SIM profile associated with the EID of the first communication device with the EID of the second communication device based on the received e-SIM transfer request message; and
transmitting, to the second communication device, the e-SIM profile mapped with the EID of the second communication device.

2. The method as claimed in claim 1, comprising:
transmitting, to a Mobile Network Operator (MNO), a configuration request message to configure a transfer of the mapped e-SIM profile from the EID of the first communication device to the EID of the second communication device; and
receiving, from the MNO in response to the transmitted configuration request message, a confirmation message indicating a confirmation of the configuration of the e-SIM profile from the EID of the first communication device to the EID of the second communication device.

3. The method as claimed in claim 1, comprising:
identifying a current state of the e-SIM profile based on receiving the e-SIM transfer request message; and
updating the current state of the e-SIM profile to a released state based on successful mapping of the e-SIM profile with the EID of the second communication device.

4. The method as claimed in claim 1, where the e-SIM profile comprises at least one of subscription-related information, one or more authentication credentials, and one or more network identifiers.

5. The method as claimed in claim 1, comprising:
transmitting, to the second communication device, a notification message including a request to install the e-SIM profile transmitted to the second communication device.

6. The method as claimed in claim 1, comprising:
detecting whether the transmitted e-SIM profile is installed on the second communication device; and
deleting the e-SIM profile from the first communication device based on detecting that the transmitted e-SIM profile is installed on the second communication device.

7. The method as claimed in claim 1, wherein the mapping process to map the e-SIM profile with the EID of the second communication device is performed independently of original equipment manufacturer (OEM) IDs associated with each of the first communication device and the second communication device.

8. A communication system, comprising:
a first communication device comprising communication circuitry;
a second communication device comprising communication circuitry; and
a server communicably coupled to the first communication device and the second communication device, the server comprising:
one or more processing units comprising at least one processor, comprising processing circuitry, individually and/or collectively, configured to:
receive, from the first communication device, an e-SIM transfer request message including an e-SIM identifier (EID) corresponding to each of the first communication device and the second communication device, wherein the received e-SIM transfer request message corresponds to a request for transferring the e-SIM profile from the first communication device to the second communication device (310);
perform a mapping process to map the e-SIM profile associated with the EID of the first communication device with the EID of the second communication device based on the received e-SIM transfer request message; and
perform control to transmit, to the second communication device, the e-SIM profile that is mapped with the EID of the second communication device.

9. The system as claimed in claim 8, wherein at least one processor, individually and/or collectively, is configured to:
perform control to transmit, to a Mobile Network Operator (MNO), a configuration request message to configure a transfer of the mapped e-SIM profile from the EID of the first communication device to the EID of the second communication device; and
receive, from the MNO in response to the transmitted configuration request message, a confirmation message indicating a confirmation of the configuration of the e-SIM profile from the EID of the first communication device to the EID of the second communication device.

10. The system as claimed in claim 8, wherein at least one processor, individually and/or collectively, is configured to:
identify a current state of the e-SIM profile based on receiving the e-SIM transfer request message; and
update the current state of the e-SIM profile to a released state based on successful mapping of the e-SIM profile with the EID of the second communication device.

11. The system as claimed in claim 8, wherein the e-SIM profile comprises at least one of subscription-related information, one or more authentication credentials, and one or more network identifiers.

12. The system as claimed in claim 8, wherein at least one processor, individually and/or collectively, is configured to:
perform control to transmit, to the second communication device, a notification message including a request to install the e-SIM profile transmitted to the second communication device.

13. The system as claimed in claim 8, wherein at least one processor, individually and/or collectively, is configured to:
detect whether the transmitted e-SIM profile is installed on the second communication device; and
delete the e-SIM profile from the first communication device based on detecting that the transmitted e-SIM profile is installed on the second communication device.

14. The system as claimed in claim 8, wherein the mapping process to map the e-SIM profile with the EID of the second communication device is performed independently of original equipment manufacturer (OEM) IDs associated with each of the first communication device and the second communication device.
